(19) United States
(12) Patent Application Publication
(10) Pub. No.: US 2024/0002735 A1
(43) Pub. Date: Jan. 4, 2024

(54) IMPROVED PROCESS FOR CONVERSION OF PLASTIC WASTE TO FUEL

(71) Applicants: Kamlesh Madanlal GUPTA, Navi Mumbai (IN); Kavita Madanlal GUPTA, Navi Mumbai (IN)

(72) Inventors: Kamlesh Madanlal GUPTA, Navi Mumbai (IN); Kavita Madanlal GUPTA, Navi Mumbai (IN)

(21) Appl. No.: 18/252,921

(22) PCT Filed: Nov. 8, 2021
(86) PCT No.: PCT/IB2021/060306

§ 371 Date: May 15, 2023

(30) Foreign Application Priority Data
Dec. 10, 2020 (IN) 202011053788

(51) Int. Cl. C10G 9/06

(52) U.S. Cl. CPC C10G 9/06; C10G 2400/08; C10G 2400/04; C10G 2400/02; C10G 2300/1003; C10G 2300/4006; C10G 2300/4012; C10G 2300/304; C10G 2300/302

(57) ABSTRACT

The present disclosure provides an improved process for conversion of a plastic waste to fuel that is economical. An aspect of the present disclosure provides an improved process for conversion of a plastic waste to fuel, said process including the steps of: (a) contacting the plastic waste with a transporting agent in a reactor to obtain a first mixture, said first mixture being in a molten state, wherein said transporting agent is a high molecular weight wax having carbon atoms ranging from 30 to 100 and molecular weight ranging from 500 to 2000; (b) effecting filtration of said first mixture to obtain a filtered molten mixture; (c) effecting thermal cracking of said filtered molten mixture to obtain an overhead stream and a bottoms stream; and (d) subjecting said overhead stream to flashing to obtain a fuel stream and a transporting agent stream.

### TECHNICAL FIELD

The present disclosure pertains to the technical field of recycling of plastic wastes. In particular, the present disclosure provides an improved process for conversion of plastic waste to fuel that is economical.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Disposal of plastic wastes has become a critical issue in today's world. Several techniques have been reported so far for recycling the plastic wastes. Natacha Phetyim and Sommai Pivsa-Art (Prototype Co-Pyrolysis of Used Lubricant Oil and Mixed Plastic Waste to Produce a Diesel-Like Fuel, Energies 2018, 11, 2973; doi: 10.3390/en11112973) studied the co-pyrolysis of used lubricant oil blended with plastic waste, namely high-density polyethylene (HDPE), polypropylene (PP), and polystyrene (PS), to produce a diesel-like fuel, content whereof is incorporated herein in its entirety by way of reference. The oil waste used in pyrolysis processes includes automotive engine oil, brake fluid, gear oil, and power steering fluid. It was reported that the oil products produced at 400-425° C. exhibited diesel-like fuel properties.

Sacha Breyer et al (Sacha Breyer, Loucine Mekhitarian, Bart Rimez, Benoit Haut, Production of an alternative fuel by the co pyrolysis of landfill recovered plastic wastes and used lubrication oils, Waste Management 60 (2017) 363-374) reported production of an alternative fuel at lab scale by co-pyrolysis of landfill recoveredplastic wastes (HDPE, LDPE, PP and PS) and used lubrication oils (motor oil, used oil), content whereof is incorporated herein in its entirety by way of reference. The possibility to produce an alternative fuel for industrial use whose viscosity is lower than 1 Pa s at 90° C., from a plastic/oil mixture with an initial plastic mass fraction between 40% and 60%, by proceeding at a maximum temperature included in the range 350-400° C. was evaluated. However, they pointed out that for industrial scale designing, heat losses should be addressed carefully.

Norbert Miskolczi and Funda Ates (Thermo-catalytic co-pyrolysis of recovered heavy oil and municipal plastic wastes, Journal of Analytical and Applied Pyrolysis 117 (2016) 273-281) reported thermo-catalytic co-pyrolysis of recovered refinery heavy oil and municipal plastic wastes at 500° C. in a stirred batch reactor using (3-zeolite, y-zeolite and m-Ni—Mo-catalysts, content whereof is incorporated herein in its entirety by way of reference. It was concluded that due to the “dilution” effect of the heavy oil, higher yields of gaseous product and pyrolysis oil were found using lower municipal plastic waste/heavy oil ratio, especially in the presence of (3-zeolite catalyst.

Numerous other reports and studies have been published so far, such as—low density polyethylene blends with vacuum gas oil (A. Marcilla, A. Gomez-Siurana, A. O. Odjo, R. Navarro, D. Berenguer, Characterization of vacuum gas oil low density polyethylene blends by thermogravimetric analysis, Polym. Degrad. Stab. 93 (2008) 723-730; A. Marcilla, J. C. Garcia-Quesada, A. Gómez, A. O. Odjo, R. N. Martinez, D. Berenguer, Flow properties of vacuum gas oil-low density polyethylene blends, Fuel Process. Technol. 89 (2008) 83-89; N. Joppert Jr., A. Araujo da Silva, M. Regina da Costa Marques, Enhanced diesel fuel fraction from waste high-density polyethylene and heavy gas oil pyrolysis using factorial design methodology, Waste Manag. 36 (2015) 166-176), co-pyrolysis of low density polyethylene with heavy oil (T. Xue-Cai, Z. Chun-Chun, L. Qing-Kun, M. Tian-Yi, Y. Pei-Qing, C. Zhen-Min, Y. Wei-Kang, Co-pyrolysis of heavy oil and low density polyethylene in the presence of supercritical water: the suppression of coke formation, Fuel Process. Technol. 118 (2014) 49-54), co-pyrolysis of HDPE with lubricant oil (Phetyim, N. Co-Pyrolysis technique between used lubricant oil and HDPE by activated zeolite catalyst. J. Eng. RMUTT 2015, 13, 75-84), co-pyrolysis of waste polyolefins with waste motor oil (Uçar, S.; Özkan, A. R.; Karagoz, S. Co-pyrolysis of waste polyolefins with waste motor oil. J. Anal. Appl. Pyrolysis 2016, 119, 233-241), and pyrolysis between used lubricant oil and polystyrene (Phetyim, N.; Sirisangsawang, R.; Pornpichet, W.; Maiket, C. Co-Pyrolysis between used lubricant oil and polystyrene using activated zeolite catalyst. KKU Res. J. 2016, 16, 112-119; Kim, S. S.; Kim, J.; Jeon, J. K.; Park, Y. K.; Park, C. J. Non-isothermal pyrolysis of mixtures of waste automobile lubricant oil and polystyrene in a stirred batch reactor. Renew. Energy 2013, 54, 241-247), contents whereof are incorporated herein in their entirety by way of references.

WO2012076890A1 reported a continuous process for recycling a waste plastics material, comprising: (i) continuously introducing into a reactor a waste plastics material as a feedstock, wherein the reactor comprises at least one reaction chamber; (ii) optionally introducing the feedstock and hydrogen gas into a dechlorination reaction chamber and maintaining the dechlorination reaction chamber at an elevated temperature T1 and at a pressure P1; recovering, where present, HCI from the dechlorination reaction chamber; and separately recovering dechlorinated feedstock from the dechlorination reaction chamber; (iii) introducing the feedstock from step (i) or, when the process involves step (ii), the dechlorinated feedstock from step (ii), and hydrogen into a hydrocracking reaction chamber and maintaining the hydrocracking reaction chamber at an elevated temperature T2 and at a pressure P2 and contacting the feedstock with a catalyst; and (iv) recovering hydrocracked feedstock from the hydrocracking reaction chamber; (v) optionally reintroducing non-hydrocracked or partially hydrocracked feedstock from the hydrocracking reaction chamber into the hydrocracking reactor chamber, content whereof is incorporated herein in its entirety by way of reference.

As can be seen from the reports mentioned hereinabove, waste oil, lubricating oil, vacuum oil, petroleum based oil, and heavy oil has been reported so far as heat recovery agents. Although usage of these oils (either singly or as mixture) as heat recovery agent may afford some cost improvement, there is a huge scope for improvement in the recycling technique such that the process can achieve desired cost-effectiveness and can be implemented at a large scale. Conventional processes also suffer from other shortcomings such as restrictions as to usage of the plastic waste, requirement of costly catalysts, restrictions on temperature range that may be employed, scalability issues and the likes.

The present disclosure provides an improved process that can be implemented at an industrial scale while achieving better cost-effectiveness as compared to the conventional processes, while alleviating one or more shortcomings associated with the conventional processes.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### OBJECTS OF THE INVENTION

It is an object of the present disclosure to provide an improved process for conversion of plastic waste to fuel.

Another object of the present disclosure is to provide a process for conversion of plastic waste to fuel that is economical.

Further object of the present disclosure is to provide a process for conversion of plastic waste to fuel that is capable of implementation at an industrial scale.

Further object of the present disclosure is to provide a process for conversion of plastic waste to fuel that is energy efficient.

Still further object of the present disclosure is to provide a process for conversion of plastic waste to fuel that can take mixed plastic waste as feedstock.

### SUMMARY

The present disclosure pertains to the technical field of recycling of plastic wastes. In particular, the present disclosure provides an improved process for conversion of plastic waste to fuel that is economical.

The present disclosure is, partly, on the premise of surprising discovery by inventors of the present disclosure that usage of high molecular wax(es) as transferring agent affords several fold technical advantages, in that—(i) the ratio of transferring agent to waste plastic feed can be kept significantly lower when high molecular wax(es) are used as transferring agent as compared to usage of heavy oil (and such other conventional oil or oil like components), which not only aids in improving processing efficiency of the plant (as more plastic waste can be processed) but also significantly improves the energy efficiency by reducing the energy consumption while pre-heating/heating the transferring agent or a mixture of transferring agent and plastic waste; (ii) usage of high molecular wax(es) are used as transferring agent affords higher yield as compared to usage of heavy oil (and such other conventional oil or oil like components); (iii) higher heat capacity of the high molecular wax(es) as compared to heavy oil circumvents (or at least alleviates) the restrictions as to the temperatures to which it can be subjected to during the process; (iv) molten plastic waste is more compatible with the high molecular wax(es) as compared to the heavy oils and low molecular wax(es); and (v) usage of high molecular wax(es) results in reduced vaporization at elevated temperatures and consequently significantly reduces heat loss during the course of the process.

Accordingly, an aspect of the present disclosure provides an improved process for conversion of a plastic waste to fuel, said process including the steps of: (a) contacting the plastic waste with a transporting agent in a reactor to obtain a first mixture, said first mixture being in a molten state, wherein said transporting agent is a high molecular weight wax having carbon atoms ranging from 30 to 100 and molecular weight ranging from 500 to 2000; (b) effecting filtration of said first mixture to obtain a filtered molten mixture; (c) effecting thermal cracking of said filtered molten mixture to obtain an overhead stream and a bottoms stream; and (d) subjecting said overhead stream to flashing to obtain a fuel stream and a transporting agent stream.

In an embodiment, the first mixture comprises the transporting agent and the plastic waste in a weight ratio ranging from 0.3 to 3.0. In an embodiment, the first mixture comprises the transporting agent and the plastic waste in a weight ratio ranging from 0.7 to 1.7. In an embodiment, the fuel stream is subjected to a separation column to separate a gaseous fraction, a gasoline rich fraction, a kerosene rich fraction, a diesel rich fraction and a naphtha rich fraction. In an embodiment, the transporting agent stream is fed to the reactor for being contacted with the plastic waste to obtain the first mixture. In an embodiment, the first mixture is at a temperature ranging from 250° C. to 400° C. In an embodiment, the first mixture is at a pressure ranging from 5 to 15 mBar. In an embodiment, the first mixture is at a pressure ranging from 0 to 5 Bar Gauge. In an embodiment, the step of thermal cracking is effected at a temperature ranging from 350° C. to 650° C. and at a pressure ranging from 150 to 300 mBar. In an embodiment, the step of thermal cracking is effected at a temperature ranging from 350° C. to 650° C. and at a pressure ranging from 0 to 5 Bar Gauge. In an embodiment, the step of flashing is effected at a temperature ranging from 350° C. to 650° C. and at a pressure ranging from 0.15 to 5 bar.

In an embodiment, the transporting agent stream is at a temperature ranging from 300° C. to 400° C. In an embodiment, the transporting agent has a melting point ranging from 90° C. to 115° C. when measured in accordance with ASTM D-3418. In an embodiment, the transporting agent has a drop melting point of 95° C. to 120° C. when measured in accordance with ASTM D-3954. In an embodiment, the transporting agent has a needle penetration of 2 to 8 mm when measured in accordance with ASTM D-1321 (5 seconds, 23° C.). In an embodiment, the transporting agent has a viscosity ranging from 10 to 100 cps when measured at 149° C. in accordance with ASTM D-3236.

In an embodiment, the plastic waste is a mixed plastic waste. In an embodiment, the mixed plastic waste includes halogen containing plastic waste such as polychloroprene, polyvinyl chloride (PVC) and the likes. In an embodiment, the first mixture is dehalogenated before effecting filtration thereof. In an embodiment, the step of dehalogenation is effected at a temperature ranging from 200° C. to 300° C.

Various objects, features, aspects and advantages of the inventive subject matter will become more apparent from the following detailed description of preferred embodiments.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary schematic of a process for conversion of a plastic waste to fuel, realized in accordance with an embodiment of the present disclosure.

FIG. 2 illustrates an exemplary graph showing weight ratios of Transferring agent and plastic waste, in accordance with embodiments of the present disclosure.

FIG. 3 illustrates an exemplary graph showing yields of the hydrocarbon fuel (i.e. total fuel yield %) when using heavy oil and high molecular weight waxes as Transferring agent, in accordance with embodiments of the present disclosure.

FIG. 4 illustrates an exemplary graph showing comparison of energy consumption when using heavy oil and high molecular weight waxes as Transferring agent, in accordance with an embodiment of the present disclosure.

### DETAILED DESCRIPTION OF THE INVENTION

The following is a detailed description of embodiments of the present invention. The embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Not withstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The following discussion provides many exemplary embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The present disclosure pertains to the technical field of recycling of plastic wastes. In particular, the present disclosure provides an improved process for conversion of a plastic waste to fuel that is economical.

Various terms as used herein are shown below. To the extent a term used in a claim is not defined below, it should be given the broadest definition persons in the pertinent art have given that term as reflected in printed publications and issued patents at the time of filing.

The term “plastic waste” as used herein, throughout the present disclosure, denotes the waste material from domestic or commercial source, such as plastic waste materials from residential sites, plastic waste materials from industrial sites, and plastic waste materials from land-fill sites, virgin plastic and virgin plastic materials such as scrap generated either during synthesis of the plastics materials or during processing of the plastics materials into the desired article. The plastic waste may includes single plastic waste, for example, polyethyelene (PE), polypropylene (PP) or may include combination/mixture of several plastic wastes such as a combination ofany of: polyethylene (PE), polypropylene (PP), polystyrene (PS), polyethylene terephthalate (PET), polychloroprene, nylon, polyvinyl chloride (PVC), polyacrylonitrile (PAN), and polyurethane (PU), but not limited thereto. The plastic waste may also include one or more halogen containing plastic materials such as polyvinyl chloride (PVC), polychloroprene and the likes. The process of the present disclosure is amenable to wide variety of plastic wastes without any significant restrictions as to the type or characteristics of the plastic waste that may subjected to the instant process. The plastic waste may have 20-50% of Polyethylene (PE), 20-50% of polypropylene (PP), 5-30% of polyvinyl chloride (PVC) and the rest being other types of plastics that are typically used for common household purposes.

The present disclosure is, partly, on the premise of surprising discovery by inventors of the present disclosure that usage of high molecular wax(es) as transferring agent affords several fold technical advantages, in that—(i) the ratio of transferring agent to waste plastic feed can be kept significantly lower when high molecular wax(es) are used as transferring agent as compared to usage of heavy oil (and such other conventional oil or oil like components), which not only aids in improving processing efficiency of the plant (as more plastic waste can be processed) but also significantly improves the energy efficiency by reducing the energy consumption while pre-heating/heating the transferring agent or a mixture of transferring agent and plastic waste; (ii) usage of high molecular wax(es) are used as transferring agent affords higher yield as compared to usage of heavy oil (and such other conventional oil or oil like components); (iii) higher heat capacity of the high molecular wax(es) as compared to heavy oil and low MW waxes circumvents (or at least alleviates) the restrictions as to the temperatures to which it can be subjected to during the process; (iv) molten plastic waste is more compatible with the high molecular wax(es) as compared to the heavy oils and low molecular wax(es); and (v) usage of high molecular wax(es) results in reduced vaporization at elevated temperatures and consequently significantly reduced heat loss during the course of the process.

Accordingly, an aspect of the present disclosure provides an improved process for conversion of a plastic waste to fuel, said process including the steps of: (a) contacting the plastic waste with a transporting agent in a reactor to obtain a first mixture, said first mixture being in a molten state, wherein said transporting agent is a high molecular weight wax having carbon atoms ranging from 30 to 100 and molecular weight ranging from 500 to 2000; (b) effecting filtration of said first mixture to obtain a filtered molten mixture; (c) effecting thermal cracking of said filtered molten mixture to obtain an overhead stream and a bottoms stream; and (d) subjecting said overhead stream to flashing to obtain a fuel stream and a transporting agent stream.

The plastic waste that may be subjected to the advantageous process of the present disclosure may be plastic waste material(s) and/or plastic waste articles from domestic or commercial source, such as plastic waste materials from residential sites, plastic waste materials from industrial sites, plastic waste materials from land-fill sites, virgin plastic and virgin plastic materials such as scrap generated during synthesis of the plastics materials, scrap generated during processing of the plastics materials into the desired article and the likes. The plastic waste may includes single plastic waste, for example, polyethyelene (PE), polypropylene (PP) or may include combination/mixture of several plastic wastes such as a combination of any of: polyethylene (PE), polypropylene (PP), polystyrene (PS), polyethylene terephthalate (PET), polychloroprene, nylon, polyvinyl chloride (PVC), polyacrylonitrile (PAN), and polyurethane (PU), but not limited thereto. The process of the present disclosure is amenable to wide variety of plastic wastes without any significant restrictions as to the type or characteristics of the plastic waste that may subjected to the instant process.

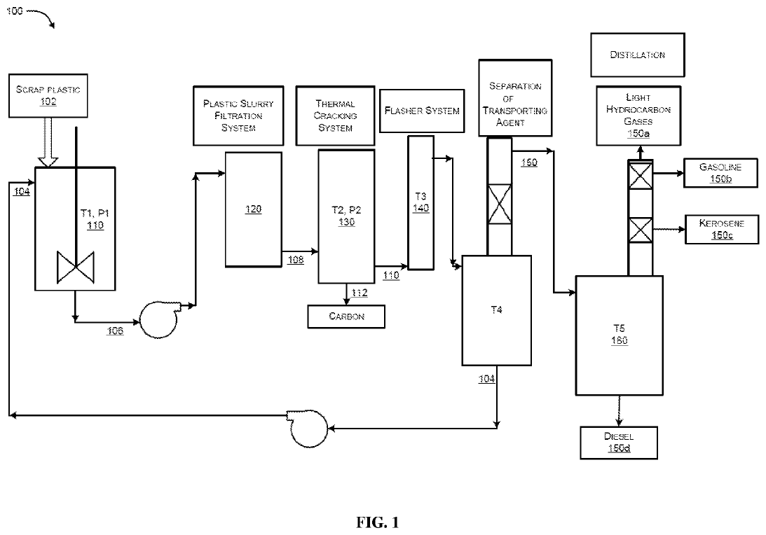

FIG. 1 illustrates an exemplary schematic of a process for conversion of a plastic waste to fuel, realized in accordance with an embodiment of the present disclosure. As can be seen from FIG. 1, the process (100) for conversion of plastic waste (102) to fuel (150) includes the steps of: (a) contacting the plastic waste (102) with a transporting agent (104) in a reactor (110) to obtain a first mixture (106), said first mixture (106) being in a molten state, wherein said transporting agent (104) is a high molecular weight wax having carbon atoms ranging from 30 to 100 and molecular weight ranging from 500 to 2000; (b) effecting filtration of said first mixture (106) to obtain a filtered molten mixture (108); (c) effecting thermal cracking of said filtered molten mixture to obtain an overhead stream (110) and a bottoms stream (112); and (d) subjecting said overhead stream (110) to flashing to obtain a fuel (150) stream and a transporting agent (104) stream. The fuel (150) stream may further be subjected to a separation column to separate a gaseous fraction (150a), a gasoline rich fraction (150b), a kerosene rich fraction (150c), a diesel rich fraction (150d) and a naphtha rich fraction.

In an embodiment, the plastic waste is a mixed plastic waste. For example, the plastic waste may have 20-50% of Polyethylene (PE), 20-50% of polypropylene (PP), 5-30% of polyvinyl chloride (PVC) and the rest being other types of plastics that are typically used for common household purposes. In an embodiment, the mixed plastic waste includes halogen containing plastic waste such as polychloroprene, polyvinyl chloride (PVC) and the likes. When the plastic waste includes one or more halogen containing plastic materials such as polyvinyl chloride (PVC), polychloroprene and the likes, dehalogenation may be effected before effecting thermal cracking, as explained in detail below.

The plastic waste may be pre-treated or pre-processed before subjecting it to the process of the present disclosure. For example, the plastic waste may be washed, chopped, shredded and/or powdered. In an embodiment, the plastic waste is shredded before introducing it in the reactor. In an embodiment, the plastic waste is chopped prior to being introduced in the reactor.

In an embodiment, the transporting agent is a high molecular weight wax (or wax like substance) having carbon atoms ranging from 30 to 100 and molecular weight ranging from 500 to 2000. The high molecular weight wax as being used as a transporting agent in the process of the present disclosure may be one or a combination of conventionally known waxes or wax like substances, each preferably having carbon atoms ranging from 30 to 100 and molecular weight ranging from 500 to 2000. For example, the high molecular weight wax may be polyethylene (PE) wax, polypropylene (PP) wax or mixtures thereof. In an embodiment, the transporting agent has a melting point ranging from 90° C. to 115° C. when measured in accordance with ASTM D-3418. In an embodiment, the transporting agent has a drop melting point of 95° C. to 120° C. when measured in accordance with ASTM D-3954. In an embodiment, the transporting agent has a needle penetration of 2 to 8 mm when measured in accordance with ASTM D-1321 (5 seconds, 23° C.). In an embodiment, the transporting agent has a viscosity ranging from 10 to 100 cps when measured at 149° C. in accordance with ASTM D-3236. Typical characterization data of commercially available PE wax (that may be used as a transferring agent) is provided in Table 1 below.

TABLE 1
Properties of PE Wax

| | | PE Wax |
|---|---|---|
| Property | Unit | (CAS No. 9002-88-4) |
| Melting Point (ASTM D-3418) | ° C. | 95 ± 5 |
| Drop Melting Point (ASTM D-3954) | ° C. | 100 ± 5 |
| Penetration (ASTM D-1321) | mm | 3 to 8 |
| 5 Sec. @ 23 Deg C. | | |
| Viscosity (ASTM D-3236)@ 149 Deg | cps | up to 100 |
| C. | | |
| Color (ASTM E-313) | — | white |
| Form | — | Prill |

In an embodiment, the transporting agent is pre-heated before it is contacted with the plastic waste. For example, the transporting agent may be pre-heated to a temperature ranging from 250° C. to 400° C. that upon coming in contact with the plastic waste in a reactor results in the molten mixture (also referred to as the “first mixture” herein synonymously and interchangeably). Alternatively, the transporting agent and the plastic waste may be conveyed to the reactor (110) and melted using suitable heating means such as heating element, coil and the likes to afford the first mixture. In an embodiment, the first mixture is at a temperature ranging from 250° C. to 400° C. In an embodiment, the first mixture is at a pressure ranging from 5 to 15 Bar Gauge. In an embodiment, the first mixture is at a pressure ranging from 5 to 15 mBar. The transporting agent and the plastic waste may be mixed in a suitable weight ratio. In an embodiment, the first mixture comprises the transporting agent and the plastic waste in a weight ratio ranging from 0.3 to 3.0. Preferably, the first mixture includes transporting agent and plastic waste in a weight ratio ranging from 0.7 to 1.7. More preferably, the first mixture includes transporting agent and plastic waste in a weight ratio ranging from 0.8 to 1.5.

The first mixture (which is in molten state) may then be subjected to one or more filtration assemblies (120) to effect filtration of said first mixture to obtain a filtered molten mixture. Filtration of the first mixture aids in removal of particulate matters that may not be melted. Any conventional filtration assembly(ies) or unit(s), as known to persons skilled in the art, that can effect removal of particulate matters or particles having size greater than 100 micron may be used. In an embodiment, the first mixture is subjected to surface type filtration with two stages, wherein in the first stage, particles having size greater than 1 mm are removed, and in the second stage, particles having size greater than 100 microns are removed to obtain filtered molten mixture. In case the plastic waste includes one or more halogen containing plastic materials such as polyvinyl chloride (PVC), polychloroprene and the likes, the first mixture is dehalogenated before effecting filtration thereof. Dehalogenation may be performed in accordance with the techniques known in the art (e.g. as disclosed in WO2012076890A1). In dehalogenation, the halogens present within the first mixture may be liberated in gas phase. These gas(es) may be extracted in a scrubber using a caustic solution. The caustic solution may have sodium hydroxide or such other bases in a concentration ranging from 1% to 10%, but not limited thereto. Scrubbing system may include spray condenser, hot well, circulating pump and heat exchanger, where these halogens may get converted into their respective salts. Any conventional scrubbing unit/system as known to persons skilled in the art may be used to aid in dehalogenation of the first mixture. In an embodiment, the step of dehalogenation is effected at a temperature ranging from 200° C. to 300° C.

The filtered molten mixture is then subjected to thermal cracking in a thermal cracking unit (130). In an embodiment, thermal cracking is effected at a temperature ranging from 350° C. to 650° C. and at a pressure ranging from 150 to 300 mBar. In an embodiment, the step of thermal cracking is effected at a temperature ranging from 350° C. to 650° C. and at a pressure ranging from 0 to 5 Bar Gauge. Alternatively, thermal cracking may be performed in accordance with the techniques known in the art. Thermal cracking affords an overhead stream and a bottoms stream. Bottoms stream may include coke that is separated.

The overhead stream from the thermal cracking is subjected to flashing. Flashing may be done in a flashing unit (flasher) (140). Any conventional flashing unit/flasher as known to persons skilled in the art may be employed for effecting flashing of the overhead stream. In an embodiment, flashing is effected at a temperature ranging from 350° C. to 650° C. and at a pressure ranging from 0.15 to 5 bar. Flashing of the overhead stream obtained from the thermal cracking unit affords the fuel stream and a transporting agent stream.

The fuel stream may further be subjected to a separation column to separate a gaseous fraction, a gasoline rich fraction, a kerosene rich fraction, a diesel rich fraction and a naphtha rich fraction. The separation column may be a distillation column (160), for example, a fractional distillation column. However, any other separation technique, as known to or appreciated by a person skilled in the art may be used for effecting separation of different fractions with requisite purity and/or concentration.

The transporting agent stream obtained from the flashing unit (140) may be fed to the reactor (110) for being contacted with the plastic waste to obtain the first mixture. In an embodiment, the transporting agent stream is at a temperature ranging from 300° C. to 400° C. For example, the transporting agent stream may be directly fed without further processing thereof. Alternatively, the transporting agent stream may be subjected to further processing such as separation of the transporting agent from other components or filtration of the transporting agent stream to get the transporting agent with desired purity. If required, the transporting agent stream may be heated to achieve the desired temperature before it is contacted with the plastic waste.

The advantageous process of the present disclosure may be run on a continuous mode or in a batch mode. Further, the process of the present disclosure is amenable to wide varieties of plastic sources without any substantial constraints as to type or characteristics of the plastic waste. The process of the present disclosure is economical as compared to conventional processes and can be implemented at an industrial scale. Further, the process of the instant disclosure does not require any costly catalyst. The advantageous process of the present disclosure is further illustrated by way of following examples.

Mixed scrap plastic including soft and hard plastic waste, was received in loose as well as in baled-form from the supplier. Upon receipt, scrap plastic was unloaded in the raw material storage area. In the pre-processing unit, the scrap plastic was de-baled, plastic was segregated manually by identifying recycling code and polypropylene (PP) and high density polyethylene (HDPE) was segregated separately (for experiments, HDPE and PP were used as plastic waste, so dehalogenation was not performed), and passed through vibratory screens and centrifuge for removal of loose dust, sand, metal and paper. Collected plastic waste was cleaned, washed and dried. Measured amount(s) of plastic waste, so obtained, was used in the process detailed in following examples.

### Example 1

375 grams of PP and 375 grams of HDPE (as obtained above) was fed to the mixing tank (reactor) having electrical heating system with temperature control. 600 gram of commercially available PE wax (CAS No. 9002-88-4) characterization data whereof is provided in Table 2 below was added to the mixing tank (as a transferring agent) and heated at a temperature (T1) of about 310° C. and at a pressure (P1) of about 10 mbar. The molten mixture was agitated for about 20 minutes after reaching the requisite temperature of about 310° C.

TABLE 2
Properties of PE Wax

| | | PE Wax |
|---|---|---|
| Property | Unit | (CAS No. 9002-88-4) |
| Melting Point (ASTM D-3418) | ° C. | 90 |
| Drop Melting Point (ASTM D-3954) | ° C. | 104 |
| Penetration (ASTM D-1321) | mm | 4 |
| 5 Sec. @ 23 Deg C. | | |
| Viscosity (ASTM D-3236)@ 149 Deg | cps | 12 |
| C. | | |
| Color (ASTM E-313) | — | white |
| Form | — | Prill |

This molten mixture was then transferred via Gear Pump through a thermal cracker and subjected to a temperature (T2) of about 530° C. and a pressure (P2) of about 200 mbar. Thermal cracker bottoms (coke) was separated, and the overhead stream was flashed in a flasher tank operated at a temperature (T3) of about 470° C. and at a pressure (P3) of about 150 mbar. The transfer time of the molten mixture from mixing tank (reactor) to flasher was about 40 minutes. PE wax (transferring agent) stream was separated having temperature (T4) of about 340° C. Fuel stream from the flashing unit (flashed hydrocarbon) was transferred to a fractional distillation column with reboiler operating temperature (T5) of about 230° C. to obtain light hydrocarbon gases, gasoline, kerosene and diesel streams. Total hydrocarbon yield obtained was 619 gram (83%), of which Light Hydrocarbon Fraction was 225 gram (30%) and Heavy Hydrocarbon Fraction was 394 gram (53%).

Comparison of High Molecular Weight Waxes and Heavy Oil as Transferring Agent

Measured amount of the plastic waste (obtained above) was fed to the hopper and mixed with either heavy oil (commercially available from Petroleum Product manufacturing society, Bhavnagar) or PE wax (characterization data whereof is provided in Table 2 above) in a mixing tank (reactor) having electrical heating system with temperature control. The mixture of plastic waste and the transferring agent was heated to form a molten mixture. The molten mixture was pumped and filtered and then fed to a thermal cracking unit. Carbon by product (coke) was separated from the cracked feed (as bottoms stream) and the remnant (overhead stream) was subjected to flashing in a flasher tank to obtain a fuel stream and a transporting agent stream. The transporting agent was recovered and recycled back to the plastic waste-transferring agent mixing tank. The fuel stream was then transferred to a fractional distillation column, wherein gas fraction, gasoline rich fraction, kerosene rich fraction, diesel rich fraction and naphtha rich fraction were separated. Table 3 below provides details of the experiments performed using heavy oil and high molecular weight waxes, wherein HDPE and PP indicates the plastic waste, T:P wt. ratio indicates wt. ratio of Transferring agent (HMW i.e. PE Wax OR heavy oil) to plastic waste, T1 indicates temperature of the molten mixture (i.e. the first mixture), P1 indicates the pressure of the molten mixture (i.e. the first mixture), T2 indicates the approximate temperature at which thermal cracking was done, P2 indicates the approximate pressure at which thermal cracking was done, T3 indicates the approximate temperature at which flashing was done, T4 indicates the approximate temperature of the transferring agent stream and T5 indicates approximate operating temperature of reboiler of the fractional distillation column.

TABLE 3
Experimental details

| | | | | | | | | | | | | | | | |
|---|---|---|---|---|---|---|---|---|---|---|---|---|---|---|---|
| | | | | | | | | Total | | | | | | | |
| | | | T:P | Petrol | Diesel | Petrol | Diesel | fuel | | | | | | | |
| HDPE | PP | Transferring | wt. | yield | Yield | yield | Yield | yield | T1 | P1 | T2 | P2 | T3 | T4 | T5 |
| (g) | (g) | agent | ratio | (g) | (g) | (%) | (%) | (%) | (° C.) | (mBar) | (° C.) | (mBar) | (° C.) | (° C.) | (° C.) |

Ex.

| | | | | | | | | | | | | | | | | |
|---|---|---|---|---|---|---|---|---|---|---|---|---|---|---|---|---|
| 1 | 250 | 250 | HMW | 1.4 | 107.0 | 378.0 | 21% | 76% | 97% | 300 | 10 | 390 | 200 | 500 | 380 | 230 |
| 2 | 250 | 250 | HMW | 1.3 | 111.0 | 380.0 | 22% | 76% | 98% | 300 | 10 | 390 | 200 | 500 | 380 | 230 |
| 3 | 250 | 250 | HMW | 1.1 | 128.0 | 306.0 | 26% | 61% | 87% | 300 | 10 | 390 | 200 | 500 | 380 | 230 |
| 4 | 375 | 375 | HMW | 1.4 | 131.0 | 488.0 | 17% | 65% | 83% | 300 | 10 | 390 | 200 | 500 | 380 | 230 |
| 5 | 0 | 750 | HMW | 1.1 | 233.0 | 413.0 | 31% | 55% | 86% | 310 | 10 | 525 | 200 | 470 | 380 | 230 |
| 6 | 200 | 550 | HMW | 0.9 | 255.0 | 371.0 | 34% | 49% | 83% | 310 | 10 | 530 | 200 | 470 | 340 | 240 |
| 7 | 0 | 750 | HMW | 0.9 | 272.0 | 342.0 | 36% | 46% | 82% | 310 | 10 | 530 | 200 | 470 | 340 | 240 |
| 8 | 375 | 375 | HMW | 0.8 | 225.0 | 394.0 | 30% | 53% | 83% | 310 | 10 | 530 | 200 | 470 | 340 | 240 |
| 9 | 375 | 375 | HMW | 1.1 | 217.0 | 263.0 | 29% | 35% | 64% | 310 | 10 | 530 | 200 | 470 | 340 | 240 |
| 10 | 250 | 285 | HMW | 1.1 | 217.0 | 263.0 | 41% | 49% | 90% | 310 | 10 | 530 | 200 | 470 | 340 | 240 |

Comparative Examples

| | | | | | | | | | | | | | | | | |
|---|---|---|---|---|---|---|---|---|---|---|---|---|---|---|---|---|
| 1 | 480 | 0 | Heavy oil | 1.1 | 44 | 90.7 | 9% | 19% | 28% | 300 | 10 | 500 | 200 | 500 | 330 | 230 |
| 2 | 0 | 650 | Heavy oil | 1.1 | 144 | 275 | 22% | 42% | 64% | 300 | 10 | 530 | 200 | 500 | 330 | 230 |
| 2 | 288 | 0 | Heavy oil | 1.6 | 19 | 121 | 7% | 42% | 49% | 300 | 10 | 500 | 200 | 500 | 330 | 230 |
| 3 | 450 | 0 | Heavy oil | 1.8 | 94 | 86 | 21% | 19% | 40% | 300 | 10 | 500 | 200 | 500 | 330 | 230 |
| 4 | 0 | 202 | Heavy oil | 2.0 | 36 | 85 | 18% | 42% | 60% | 300 | 10 | 500 | 200 | 500 | 330 | 230 |
| 5 | 300 | 0 | Heavy oil | 2.0 | 33 | 128 | 11% | 43% | 54% | 300 | 10 | 500 | 200 | 500 | 330 | 230 |
| 6 | 400 | 0 | Heavy oil | 2.0 | 43 | 139 | 11% | 35% | 46% | 300 | 10 | 500 | 200 | 500 | 340 | 230 |
| 7 | 0 | 280 | Heavy oil | 2.0 | 33 | 69.5 | 12% | 25% | 37% | 300 | 10 | 550 | 200 | 500 | 330 | 230 |
| 8 | 300 | 300 | Heavy oil | 2.0 | 26 | 262.5 | 4% | 44% | 48% | 300 | 10 | 500 | 200 | 470 | 330 | 230 |
| 9 | 100 | 100 | Heavy oil | 2.0 | 40 | 53 | 20% | 27% | 47% | 300 | 10 | 540 | 200 | 470 | 340 | 230 |
| 10 | 810 | 0 | Heavy oil | 2.0 | 85.5 | 395.5 | 11% | 49% | 59% | 300 | 10 | 500 | 200 | 500 | 330 | 230 |

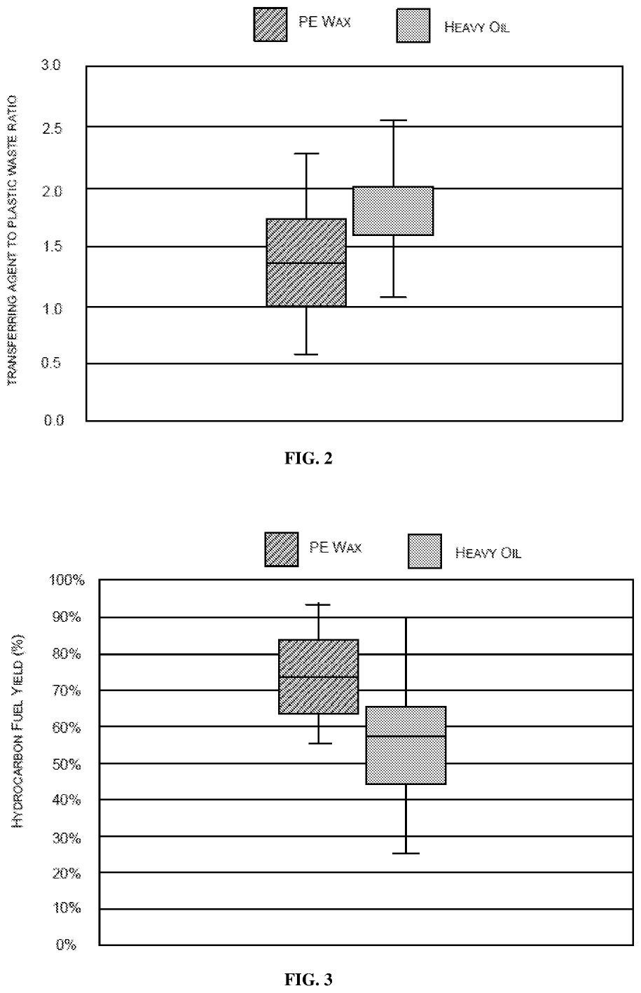

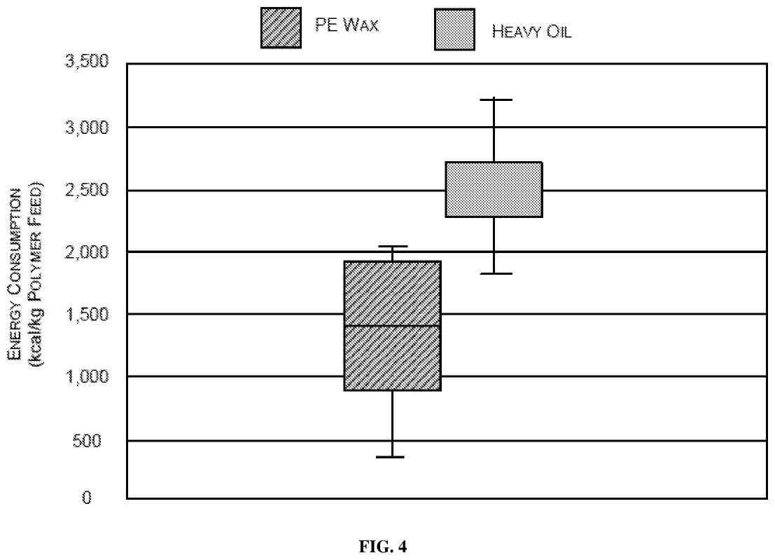

FIG. 2 illustrates an exemplary graph showing weight ratios of Transferring agent and plastic waste employed in experiments; FIG. 3 illustrates an exemplary graph showing yields of the hydrocarbon fuel (i.e. total fuel yield %) when using heavy oil and high molecular weight waxes as Transferring agent; and FIG. 4 illustrates an exemplary graph showing comparison of energy consumption when using heavy oil and high molecular weight waxes as Transferring agent. As can be seen from FIGS. 2-4, when high molecular weight wax(es) are used as transferring agent, it affords usage of lower transferring agent to plastic waste weight ratio, improved yield of hydrocarbon fuels, and significantly reduced energy consumption resulting in energy efficiency and significant economy.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### Advantages of the Present Invention

The present disclosure provides an improved process for conversion of plastic waste to fuel.

The present disclosure provides a process for conversion of plastic waste to fuel that is economical.

The present disclosure provides a process for conversion of plastic waste to fuel that is capable of implementation at an industrial scale.

The present disclosure provides a process for conversion of plastic waste to fuel that is energy efficient.

The present disclosure provides a process for conversion of plastic waste to fuel that can take mixed plastic waste as feedstock.

We claim:

1. An improved process for conversion of a plastic waste to fuel, said process comprising the steps of:
contacting the plastic waste with a transporting agent in a reactor to obtain a first mixture, said first mixture being in a molten state, wherein said transporting agent is a high molecular weight wax having carbon atoms ranging from 30 to 100 and molecular weight ranging from 500 to 2000;
effecting filtration of said first mixture to obtain a filtered molten mixture;
effecting thermal cracking of said filtered molten mixture to obtain an overhead stream and a bottoms stream, said step of thermal cracking being effected at a temperature ranging from 350° C. to 650° C. and at a pressure ranging from 0 to 5 Bar Gauge; and
subjecting said overhead stream to flashing at a temperature ranging from 350° C. to 650° C. and at a pressure ranging from 0.15 to 5 bar to obtain a fuel stream and a transporting agent stream.

2. The process as claimed in claim 1, wherein said first mixture comprises the transporting agent and the plastic waste in a weight ratio ranging from 0.3 to 3.0.

3. The process as claimed in claim 1, wherein said fuel stream is subjected to a separation column to separate a gaseous fraction, a gasoline rich fraction, a kerosene rich fraction, a diesel rich fraction and a naphtha rich fraction.

4. The process as claimed in claim 1, wherein said transporting agent stream is fed to the reactor for being contacted with the plastic waste to obtain the first mixture.

5. The process as claimed in claim 1, wherein said first mixture is at a temperature ranging from 250° C. to 400° C. and a pressure ranging from 0 to 5 Bar Gauge.

6. The process as claimed in claim 1, wherein said transporting agent stream is at a temperature ranging from 300° C. to 400° C.

7. The process as claimed in claim 1, wherein said transporting agent has a melting point ranging from 90° C. to 115° C. when measured in accordance with ASTM D-3418, a drop melting point of 95° C. to 120° C. when measured in accordance with ASTM D-3954, and a needle penetration of 2 to 8 mm, when measured in accordance with ASTM D-1321 (5 seconds, 23° C.).

8. The process as claimed in claim 1, wherein said transporting agent has a viscosity ranging from 10 to 100 cps when measured at 149° C. in accordance with ASTM D-3236.

9. The process as claimed in claim 1, wherein said plastic waste is a mixed plastic waste, said mixed plastic waste including halogen containing plastic waste, and wherein said first mixture is dehalogenated at a temperature ranging from 200° C. to 300° C. before effecting filtration thereof.
